(19) United States
(12) Patent Application Publication
(10) Pub. No.: US 2024/0304851 A1
(43) Pub. Date: Sep. 12, 2024

(54) METHOD FOR MANUFACTURING NON-AQUEOUS ELECTROLYTIC SOLUTION SECONDARY BATTERY

(71) Applicant: Prime Planet Energy & Solutions, Inc., Tokyo (JP)

(72) Inventors: Masaki MAEDA, Kobe-shi (JP); Masahide MIYAKE, Kobe-shi (JP); Junichi YOGO, Sennan-shi (JP)

(21) Appl. No.: 18/443,296

(22) Filed: Feb. 16, 2024

(30) Foreign Application Priority Data
Mar. 8, 2023 (JP) 2023-035882

(51) Int. Cl. H01M 10/04; H01M 10/0525

(52) U.S. Cl. CPC H01M 10/0481; H01M 10/0468; H01M 10/0525; H01M 2220/20

(57) ABSTRACT

A manufacturing method disclosed herein includes: a step of constructing a battery assembly in which an electrode body and a non-aqueous electrolytic solution are accommodated in a battery case, the electrode body including a positive electrode and a negative electrode laminated on each other across a separator; a step of initially charging the battery assembly; a high-temperature holding step of holding the battery assembly after subjected to the initial charging step at a high temperature equal to or greater than 40° C.; an ordinary-temperature holding step of holding the battery assembly at an ordinary temperature for a duration exceeding 3 hours after the high-temperature holding step; and a degassing step of pressing the battery assembly after subjected to the ordinary-temperature holding step in a laminating direction of the electrode body and releasing the battery assembly.

### CROSS REFERENCE TO RELATED APPLICATION

The present application claims priority from Japanese Patent Application No. 2023-035882, filed on Mar. 8, 2023. The entire teachings of this application are incorporated into the present specification by reference.

### BACKGROUND OF THE DISCLOSURE

### 1. Field

The present disclosure relates to a method for manufacturing a non-aqueous electrolytic solution secondary battery.

### 2. Background

Secondary batteries such as lithium ion secondary batteries are widely used in various fields. For example, the secondary batteries are used in power sources for driving vehicles such as hybrid electric vehicles, plug-in hybrid electric vehicles, and battery electric vehicles. One type of such secondary batteries is a non-aqueous electrolytic solution secondary battery using a non-aqueous electrolytic solution as an electrolyte. Such a non-aqueous electrolytic solution secondary battery is generally manufactured by preparing a battery assembly in which an electrode body and a non-aqueous electrolytic solution are accommodated in a battery case, and performing initial charging, high-temperature aging, etc. on the battery assembly.

Japanese Patent Application Laid-Open No. 2000-90974 and Japanese Patent Application Laid-Open No. 2020-149802 describe methods for manufacturing non-aqueous electrolytic solution secondary batteries such as those described above. For example, Japanese Patent Application Laid-Open No. 2000-90974 states that an electrode body and an electrolytic solution are accommodated in a battery case, a decompressing process is performed during preliminary charging or after the preliminary charging, and then an opening part of the battery case is closed. Japanese Patent Application Laid-Open No. 2020-149802 states that a battery assembly is constructed in which an electrode body and a non-aqueous electrolytic solution are accommodated, the battery assembly is bound, and then initial charging is performed, and further states that the binding of the battery assembly is relaxed after the initial charging and then a pumping step of applying a binding pressure again is performed.

### SUMMARY

During charging of a battery assembly, various reactions proceed inside an electrode body in response to the charging. As an example, in a non-aqueous electrolytic solution secondary battery, a coating called a solid electrolyte interface (SEI) membrane may be formed on a surface of a negative electrode active material as a result of reductive decomposition of part of a non-aqueous electrolytic solution occurring during initial charging. If such reaction responsive to the charging proceeds, gas may be generated inside the electrode body. The gas remaining inside the electrode body causes a risk of reducing a battery capacity. According to the technology described in Japanese Patent Application Laid-Open No. 2000-90974, the decompressing process is performed after the preliminary charging to emit gas favorably. However, the present inventors have conducted examination and found that merely emitting gas after the preliminary charging causes reduction in the capacity of a secondary battery.

The present disclosure has been made in view of this issue, and is intended to provide a manufacturing method that improves the battery capacity of a secondary battery.

A manufacturing method disclosed herein includes: a step of constructing a battery assembly in which an electrode body and a non-aqueous electrolytic solution are accommodated in a battery case, the electrode body including a positive electrode and a negative electrode laminated on each other across a separator; a step of initially charging the battery assembly; a high-temperature holding step of holding the battery assembly after subjected to the initial charging step at a high temperature equal to or greater than 40° C.; an ordinary-temperature holding step of holding the battery assembly at an ordinary temperature for a duration exceeding 3 hours after the high-temperature holding step; and a degassing step of pressing and releasing the battery assembly after subjected to the ordinary-temperature holding step in a laminating direction of the electrode body.

Holding the battery assembly at the ordinary temperature after the initial charging and the high-temperature holding allows various reactions proceeding in response to the charging inside the electrode body to be nearly completed. This makes it possible to inhibit generation of additional gas. Thus, by performing the degassing step with timing after the ordinary-temperature holding step, it becomes possible to emit gas remaining inside the electrode body favorably to the outside of the electrode body. Eliminating remaining gas inside the electrode body improves a battery capacity. As a result, with this configuration, it is possible to realize the manufacturing of a secondary battery with an improved battery capacity.

### BRIEF DESCRIPTION OF THE DRAWINGS

FIG. 1 is a flowchart describing a manufacturing method according to an embodiment;

FIG. 2 is a perspective view schematically showing a battery according to the embodiment;

FIG. 3 is a vertical sectional view schematically showing an internal configuration of the battery according to the embodiment;

FIG. 4 is a view schematically showing the configuration of an electrode body according to the embodiment; and

FIG. 5 is a graph showing a relationship between a holding duration in an ordinary-temperature holding step and a discharged capacity.

### DETAILED DESCRIPTION OF THE PREFERRED EMBODIMENTS

Hereinafter, an embodiment of a technology disclosed herein will be described by referring to the drawings. Any feature other than features specifically set forth in the present specification and necessary for carrying out the technology disclosed herein (such as a general configuration of and manufacturing process for a battery not characterizing the technology disclosed herein, for example) can be understood as a design matter that a person skilled in the art can address on the basis of conventional technology in the pertinent field. The technology disclosed herein can be carried out on the basis of a substance disclosed in the present specification and technical knowledge in the pertinent field.

In addition, an expression “from A to B” indicating a range in the present specification (A and B are any numerical values) means a range equal to or greater than A and equal to or less than B.

In the present specification, a “non-aqueous electrolytic solution secondary battery” refers to a general battery using a non-aqueous electrolytic solution as an electrolyte and capable of being be charged and discharged repeatedly. A typical example of such a non-aqueous electrolytic solution secondary battery is a lithium ion secondary battery. The lithium ion secondary battery is a secondary battery that uses lithium (Li) ions as electrolytic ions (charge carrier) and is charged and discharged by transfer of lithium ions between a positive electrode and a negative electrode. Furthermore, in the present specification, an “active material” means a material used for storing and releasing the charge carrier in a reversible manner. In the following embodiment, a lithium ion secondary battery is used as a non-aqueous electrolytic solution secondary battery. However, the technology disclosed herein is not limited to lithium ion secondary batteries but is applicable to other types of non-aqueous electrolytic solution secondary batteries (sodium ion batteries, for example).

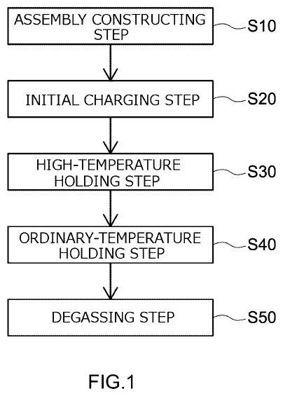

FIG. 1 is a flowchart showing general steps of a manufacturing method disclosed herein. As shown in FIG. 1, the manufacturing method disclosed herein includes an assembly constructing step S10, an initial charging step S20, a high-temperature holding step S30, an ordinary-temperature holding step S40, and a degassing step S50. The manufacturing method disclosed herein is characterized in that, after implementation of the high-temperature holding step S30 of holding a battery assembly at a temperature equal to or greater than 60° C., the ordinary-temperature holding step S40 of holding the battery assembly at an ordinary temperature for a duration exceeding 3 hours is performed, and after implementation of the ordinary-temperature holding step S40, the degassing step S50 is performed in which the battery assembly is pressed in a laminating direction of an electrode body and released. Thus, the other manufacturing processes can be similar to conventional processes. Furthermore, an additional step may be performed at an optional stage.

According to the manufacturing method disclosed herein, a gas remaining inside the electrode body can be eliminated favorably by performing the ordinary-temperature holding step S40 after implementations of the initial charging step S20 and the high-temperature holding step S30 and then performing the degassing step S50, as described above. The reason for fulfilling such effect is estimated as follows while this estimation is not intended to limit the technology disclosed herein. After the battery assembly is initially charged, the battery assembly is held at a high temperature, thereby facilitating various reactions responsive to the charging inside the electrode body. As an example, formation of a coating called a solid electrolyte interface (SEI) membrane is facilitated on a surface of a negative electrode. As the reactions responsive to the charging proceed inside the electrode body, gas may be generated as a result of the reactions. Remaining of such gas inside the electrode body may reduce a battery capacity (discharged capacity) for reason such as increased internal resistance. While these reactions have been considered to be facilitated by holding the battery assembly at a high temperature, examination conducted by the present inventors shows that, even after the high-temperature holding is finished, the reactions are still facilitated with residual heat, for example. In view of this, holding the battery assembly for a duration exceeding 3 hours at an ordinary temperature after the high-temperature holding step allows the reaction inside the electrode body to be nearly completed, so that the generation of additional gas can be inhibited. Then, by performing the degassing step with timing of completion of the ordinary-temperature holding step, it becomes possible to eliminate the gas remaining inside the electrode body favorably. With this configuration, it is possible to realize a manufacturing method that improves the battery capacity of a non-aqueous electrolytic solution secondary battery favorably.

The manufacturing method disclosed herein will be described in detail by referring to the drawings.

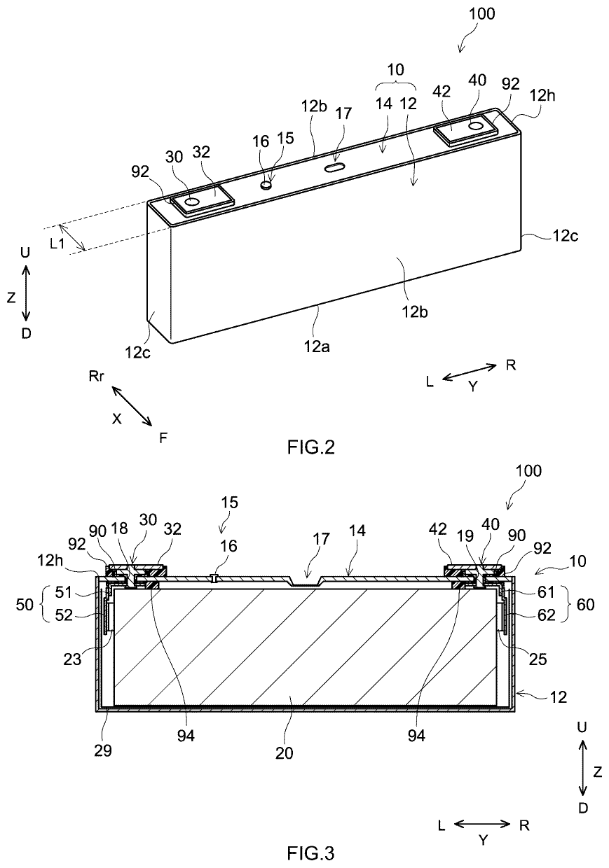

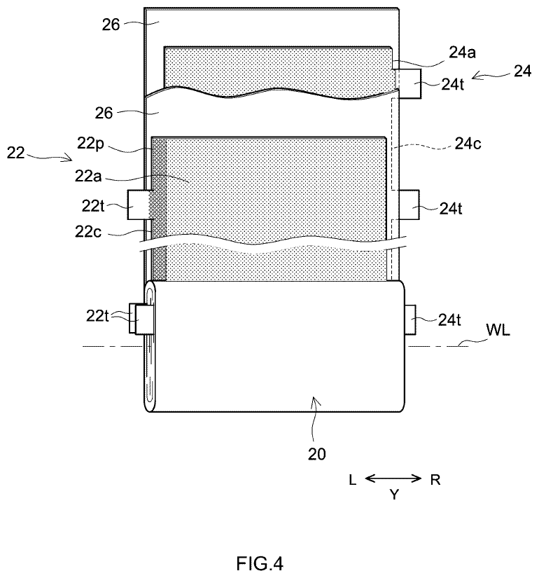

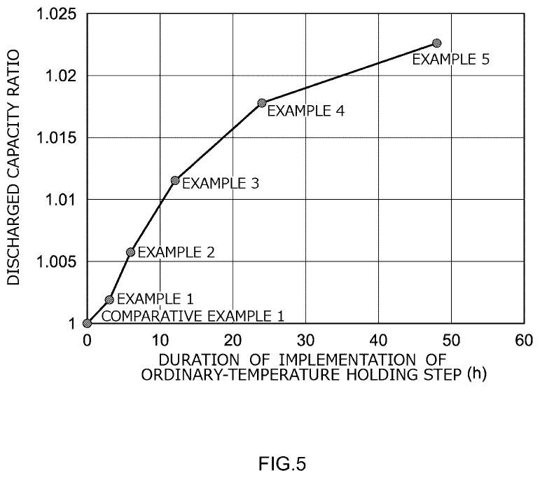

FIG. 2 is a perspective view schematically showing a battery assembly constructed by the manufacturing method disclosed herein. FIG. 3 is a view schematically showing an internal configuration of the battery assembly constructed by the manufacturing method disclosed herein. FIG. 4 is a view schematically showing the configuration of an electrode body included in the battery assembly constructed by the manufacturing method disclosed herein. In the following description, signs L, R, F, Rr, U, and D in the drawings indicate left, right, front, rear, up, and down respectively, and signs X, Y, and Z in the drawings indicate a short side direction of the battery assembly, a long side direction perpendicular to the short side direction, and a top-down direction respectively. However, these directions are merely defined for the convenience of description and are never intended to limit a way in which the battery assembly is installed.

In the assembly constructing step S10, a battery assembly 100 is constructed in which an electrode body 20 and a non-aqueous electrolytic solution not shown in the drawings are accommodated in a battery case 10. The assembly constructing step S10 may include a step of preparing the battery case 10, the electrode body 20, and the non-aqueous electrolytic solution, a step of accommodating the prepared electrode body 20 into the battery case 10, and a step of filling the non-aqueous electrolytic solution into the battery case 10 in which the electrode body 20 is accommodated, for example.

In the assembly constructing step S10, the battery case 10 is prepared first. The battery case 10 includes a case body 12 and a closing plate 14. Here, as shown in FIGS. 2 and 3, the battery case 10 has a flat rectangular solid (square) outer shape. A material for the battery case 10 can be the same as a material conventionally used and is not particularly limited. The battery case 10 (case body 12 and closing plate 14) is composed of aluminum, an aluminum alloy, stainless steel, iron, or an iron alloy, for example.

The case body 12 is a housing in which the electrode body 20 and the non-aqueous electrolytic solution are accommodated. The case body 12 is a square container with a closed bottom having one side surface (here, an upper surface) where an opening 12h is provided. Here, the opening 12h has a substantially rectangular shape. As shown in FIG. 2, the case body 12 includes a rectangular bottom surface 12a with long sides and short sides, longer walls 12b in a pair extending upward from the long sides of the bottom surface 12a and facing each other, and shorter walls 12c in a pair extending upward from the short sides of the bottom surface 12a and facing each other.

The closing plate 14 is a plate-like member having a rectangular shape here and used for closing the opening 12h of the case body 12. The closing plate 14 faces the bottom surface 12a of the case body 12. As shown in FIG. 3, the closing plate 14 has two terminal fit holes 18 and 19 penetrating the closing plate 14 in a thickness direction. The terminal fit holes 18 and 19 are provided one by one at opposite end portions of the closing plate 14 in the long side direction Y. The terminal fit hole 18 on one side (left side in FIG. 3) is for a positive electrode and the terminal fit hole 19 on the other side (right side in FIG. 3) is for a negative electrode. The closing plate 14 is provided with a liquid filling hole 15 and a gas exhaust valve 17. The liquid filling hole 15 is a through hole through which an electrolytic solution is filled into the battery case 10 after the closing plate 14 is incorporated with the case body 12. The liquid filling hole 15 is sealed with a sealing member 16 after filling of the electrolytic solution. The gas exhaust valve 17 is a thin part configured to break if a pressure in the battery case 10 becomes equal to or greater than a predetermined value, thereby exhausting gas in the battery case 10 to the outside.

A positive electrode terminal 30 and a negative electrode terminal 40 are members both to be fixed to the closing plate 14 in a finished battery. The positive electrode terminal 30 is arranged on one side of the closing plate 14 in the long side direction Y (left side in FIGS. 2 and 3). The positive electrode terminal 30 is electrically connected to a plate-like positive electrode external conductive member 32 outside the battery case 10. Preferably, the positive electrode terminal 30 is composed of metal and more preferably, composed of aluminum or an aluminum alloy, for example. The negative electrode terminal 40 is arranged on the other side of the closing plate 14 in the long side direction Y (right side in FIGS. 2 and 3). The negative electrode terminal 40 is electrically connected to a plate-like negative electrode external conductive member 42 outside the battery case 10. Preferably, the negative electrode terminal 40 is composed of metal and more preferably, composed of copper or a copper alloy, for example. The positive electrode external conductive member 32 and the negative electrode external conductive member 42 are members where a bus bar is to be provided in connecting a plurality of secondary batteries electrically. Preferably, each of the positive electrode external conductive member 32 and the negative electrode external conductive member 42 is composed of metal and more preferably, composed of aluminum or an aluminum alloy, for example. However, the positive electrode external conductive member 32 and the negative electrode external conductive member 42 are not essential members but are omissible in other embodiments.

In the assembly constructing step S10, the electrode body 20 including a positive electrode 22, a negative electrode 24, and a separator 26 is prepared. Here, as shown in FIG. 2, the electrode body 20 is a wound electrode body formed by laminating the strip-shape positive electrode 22 and the strip-shape negative electrode 24 on each other while insulation is provided therebetween across two strip-shape separators 26, and winding the laminated body about a winding axis WL in a lengthwise direction. Alternatively, the electrode body 20 may be a laminated electrode body formed by laminating a square positive electrode and a square negative electrode on each other while insulation is provided therebetween.

As shown in FIG. 4, the positive electrode 22 (hereinafter also called a “positive electrode sheet 22”) is an elongated strip-shape member. The configuration of the positive electrode sheet 22 is not particularly limited but can be similar to that used in a conventional publicly-known battery. For example, the positive electrode 22 has a positive electrode collector 22c, and a positive electrode active material layer 22a and a positive electrode protective layer 22p arranged on at least one surface of the positive electrode collector 22c. However, the positive electrode protective layer 22p is not essential but is omissible in other embodiments.

The positive electrode collector 22c has a strip shape. The positive electrode collector 22c is composed of conductive metal such as aluminum, an aluminum alloy, nickel, or stainless steel, for example. Here, the positive electrode collector 22c is metal foil, more specifically, aluminum foil. The size of the positive electrode collector 22c is not particularly limited but can be determined properly in response to battery design. The positive electrode collector 22c has a thickness that is preferably from 2 to 30 μm, more preferably, from 2 to 20 μm, still more preferably, from 5 to 15 μm. The positive electrode collector 22c has one end portion in the long side direction Y (left end portion in FIG. 4) provided with a plurality of positive electrode tabs 22t. The positive electrode tabs 22t project toward one side in the long side direction Y (left side in FIG. 4). The positive electrode tabs 22t project further in the long side direction Y than the separator 26. The positive electrode tab 22t forms part of the positive electrode collector 22c and is composed of the metal foil (aluminum foil). In at least part of the positive electrode tab 22t, the positive electrode active material layer 22a and the positive electrode protective layer 22p are not formed to expose the positive electrode collector 22c.

As shown in FIG. 4, the positive electrode active material layer 22a is provided in a lengthwise direction of the strip-shape positive electrode collector 22c. The positive electrode active material layer 22a contains a positive electrode active material. The positive electrode active material to be used can be a publicly-known positive electrode active material used in lithium ion secondary batteries. As a specific example, the positive electrode active material to be used can be a lithium composite oxide or a lithium transition metal phosphate compound. The positive electrode active material has a crystal structure that is not particularly limited but can be a layered crystal structure, a spinel structure, or an olivine structure, for example. Preferably, the lithium composite oxide is a lithium transition metal composite oxide containing a transition metallic element that is at least one type out of Ni, Co, and Mn, and examples thereof include a lithium-nickel-based composite oxide, a lithium-cobalt-based composite oxide, a lithium-manganese-based composite oxide, a lithium-nickel-manganese-based composite oxide, a lithium-nickel-cobalt-manganese-based composite oxide, a lithium-nickel-cobalt-aluminum-based composite oxide, and a lithium-iron-nickel-manganese-based composite oxide. These positive electrode active materials may each be used alone, or two or more types thereof may be used in combination.

The positive electrode active material layer 22a may contain a component such as a conductive material or a binder, for example, other than the positive electrode active material. The conductive material to be used suitably may be carbon black such as acetylene black (AB) or other types of carbon materials (e.g., graphite), for example. The binder to be used may be polyvinylidene fluoride (PVDF), for example.

While the content of the positive electrode active material in the positive electrode active material layer 22a (specifically, the content of the positive electrode active material relative to the total mass of the positive electrode active material layer 22a) is not particularly limited, it is preferably equal to or greater than 70% by mass, more preferably, equal to or greater than 80% by mass and equal to or less than 97% by mass, still more preferably, equal to or greater than 85% by mass and equal to or less than 96% by mass. While the content of the conductive material in the positive electrode active material layer 22a is not particularly limited, it is preferably equal to or greater than 1% by mass and equal to or less than 15% by mass, more preferably, equal to or greater than 3% by mass and equal to or less than 13% by mass. While the content of the binder in the positive electrode active material layer 22a is not particularly limited, it is preferably equal to or greater than 1% by mass and equal to or less than 15% by mass, more preferably, equal to or greater than 1.5% by mass and equal to or less than 10% by mass. While the thickness of the positive electrode active material layer 22a is not particularly limited, it is preferably equal to or greater than 10 μm and equal to or less than 200 μm, for example, and may be equal to or greater than 50 μm and equal to or less than 100 μm.

As shown in FIG. 4, the positive electrode protective layer 22p is provided at a boundary between the positive electrode collector 22c and the positive electrode active material layer 22a in the long side direction Y. Here, the positive electrode protective layer 22p is provided at one end portion of the positive electrode collector 22c in the long side direction Y (left end portion in FIG. 4). Alternatively, the positive electrode protective layer 22p may be provided at both the end portions in the long side direction Y. The positive electrode protective layer 22p is provided in a strip shape along the positive electrode active material layer 22a. The positive electrode protective layer 22p contains an inorganic filler (alumina, for example). With an entire solid content of the positive electrode protective layer 22p defined as 100% by mass, the inorganic filler takes up a ratio that may generally be equal to or greater than 50% by mass, typically equal to or greater than 70% by mass, which is equal to or greater than 80% by mass, for example. The positive electrode protective layer 22p may contain an optional component such as a conductive material, a binder, or each type of additive component, for example, other than the inorganic filler.

The positive electrode sheet 22 can be prepared by following a publicly-known method. For example, the positive electrode sheet 22 can be prepared by producing positive electrode paste containing the positive electrode active material and an optional component, applying the positive electrode paste to the positive electrode collector 22c, drying the positive electrode paste, and performing pressing, as necessary. In the present specification, the term “paste” is used as a term covering configurations called “slurry” and “ink.”

As shown in FIG. 4, the negative electrode 24 (hereinafter also called a “negative electrode sheet 24”) is an elongated strip-shape member. The configuration of the negative electrode sheet 24 is not particularly limited but can be similar to that used in a conventional publicly-known battery. For example, the negative electrode 24 has a negative electrode collector 24c and a negative electrode active material layer 24a arranged on at least one surface of the negative electrode collector 24c.

The negative electrode collector 24c has a strip shape. The negative electrode collector 24c is composed of conductive metal such as copper, a copper alloy, nickel, or stainless steel, for example. Here, the negative electrode collector 24c is metal foil, more specifically, copper foil. The size of the negative electrode collector 24c is not particularly limited but can be determined properly in response to battery design. The negative electrode collector 24c has a thickness that is equal to or greater than 5 μm and equal to or less than 35 μm, for example, and is preferably equal to or greater than 7 μm and equal to or less than 20 μm. The negative electrode collector 24c has one end portion in the long side direction Y (right end portion in FIG. 4) provided with a plurality of negative electrode tabs 24t. The negative electrode tabs 24t project further in the long side direction Y than the separator 26. The negative electrode tabs 24t are arranged at an interval (intermittently) in a lengthwise direction of the negative electrode 24. The negative electrode tab 24t projects toward one side in the long side direction Y (right side in FIG. 4). The negative electrode tabs 24t forms part of the negative electrode collector 24c and is composed of the metal foil (copper foil). The negative electrode active material layer 24a is formed in part of the negative electrode tab 24t. In at least part of the negative electrode tab 24t, the negative electrode active material layer 24a is not formed to expose the negative electrode collector 24c.

As shown in FIG. 4, the negative electrode active material layer 24a is provided in a lengthwise direction of the strip-shape negative electrode collector 24c. The negative electrode active material layer 24a contains a negative electrode active material. While the negative electrode active material is not particularly limited, a carbon material such as graphite, hard carbon, or soft carbon may be used, for example. The graphite may either be natural graphite or artificial graphite. The graphite may also be graphite coated with amorphous carbon having a configuration where graphite is coated with an amorphous carbon material.

The negative electrode active material layer 24a may contain a component such as a binder or a thickening agent, for example, other than the negative electrode active material. The binder to be used may be styrene-butadiene rubber (SBR) or polyvinylidene fluoride (PVDF), for example. The thickening agent to be used may be carboxymethyl cellulose (CMC), for example.

The content of the negative electrode active material in the negative electrode active material layer 24a is preferably equal to or greater than 90% by mass, more preferably, equal to or greater than 95% by mass and equal to or less than 99.9% by mass. The content of the binder in the negative electrode active material layer 24a is preferably equal to or greater than 0.1% by mass and equal to or less than 8% by mass, more preferably, equal to or greater than 0.5% by mass and equal to or less than 3% by mass. The content of the thickening agent in the negative electrode active material layer 24a is preferably equal to or greater than 0.3% by mass and equal to or less than 3% by mass, more preferably, equal to or greater than 0.5% by mass and equal to or less than 2% by mass. While the thickness of the negative electrode active material layer 24a is not particularly limited, it is equal to or greater than 10 μm and equal to or less than 200 μm, for example, and is preferably equal to or greater than 50 μm and equal to or less than 100 μm.

The negative electrode 24 can be prepared by following a publicly-known method. For example, the negative electrode 24 can be prepared by producing negative electrode paste containing the negative electrode active material and an optional component, applying the negative electrode paste to the negative electrode collector 24c, drying the negative electrode paste, and performing pressing, as necessary.

The separator 26 is an insulating resin sheet with a plurality of fine through holes allowing a charge carrier to pass therethrough. The configuration of the separator 26 is not particularly limited but can be similar to that used in a conventional publicly-known battery. For example, the separator 26 is a porous sheet (film) composed of resin such as polyethylene (PE), polypropylene (PP), polyester, cellulose, or polyamide. A heat resistant layer (HRL) may be provided on a surface of the separator 26.

The electrode body 20 can be produced by following a publicly-known method. If the electrode body 20 is a wound electrode body as illustrated in the drawing, this wound electrode body can be prepared as follows, for example. First, the strip-shape positive electrode 22 and the strip-shape negative electrode 24 are laminated on each other in such a manner as to provide insulation therebetween across the two strip-shape separators 26. At this time, as shown in FIG. 4, the positive electrode 22 and the negative electrode 24 are superimposed on each other in such a manner that the positive electrode tabs 22t of the positive electrode sheet 22 and the negative electrode tabs 24t of the negative electrode sheet 24 stick out from the end portions of the two separators 26 in the long side direction Y toward directions opposite to each other. Next, the prepared laminated body is wound in the lengthwise direction about the winding axis WL. At this time, the positive electrode tabs 22t are laminated in a plurality of layers on one side of the long side direction Y to form a positive electrode tab group 23 (see FIG. 3). Furthermore, the negative electrode tabs 24t are laminated in a plurality of layers on one side of the long side direction Y to form a negative electrode tab group 25 (see FIG. 3). The laminated body can be wound by following a publicly-known method. The wound laminated body is pressed to produce a wound electrode body having a flat shape. This pressing is not particularly limited but can be performed using a publicly-known press unit used in manufacturing a general wound electrode body having a flat shape. In this way, the electrode body 20 can be prepared.

Furthermore, in the assembly constructing step S10, the non-aqueous electrolytic solution is prepared. The non-aqueous electrolytic solution is not particularly limited but can be similar to that used in a conventional publicly-known battery. The non-aqueous electrolytic solution contains a non-aqueous solvent and an electrolytic salt (supporting salt). For example, ethylene carbonate (EC), diethyl carbonate (DEC), dimethyl carbonate (DMC), or ethyl methyl carbonate (EMC) can be used as the non-aqueous solvent. Various lithium salts can be used as the supporting salt and in particular, lithium salts such as LiPF₆ and LiBF₄ are preferred.

The non-aqueous electrolytic solution may contain various types of additives such as a film-forming agent, a gas generating agent, a dispersant, and a thickening agent, for example. Specific examples of the film-forming agent include: carbonate compounds such as vinylene carbonate (VC), vinyl ethylene carbonate (VEC), fluoroethylene carbonate (FEC), chloroethylene carbonate, and methylphenyl carbonate; and lithium salts containing anions that are oxalate complexes such as lithium bis(oxalato)borate (LiBOB), lithium difluoro(oxalato)borate (LiFOB), and lithium difluorobis(oxalato)phosphate (LPFO).

In the assembly constructing step S10, the prepared electrode body 20 is accommodated in the battery case 10. First, a positive electrode collector unit 50, a negative electrode collector unit 60, and the closing plate 14 are mounted on the electrode body 20 to form a combined member. As shown in FIG. 3, the positive electrode collector unit 50 is a member including a positive electrode first collector unit 51 that is a plate-like conductive member extending in the long side direction Y along an inner side surface of the closing plate 14, and a positive electrode second collector unit 52 that is a plate-like conductive member extending in the top-down direction Z. As shown in FIG. 3, the negative electrode collector unit 60 is a member including a negative electrode first collector unit 61 that is a plate-like conductive member extending in the long side direction Y along the inner side surface of the closing plate 14, and a negative electrode second collector unit 62 that is a plate-like conductive member extending in the top-down direction Z.

More specifically, first, the positive electrode second collector unit 52 is joined to the positive electrode tab group 23 of the electrode body 20 and the negative electrode second collector unit 62 is joined to the negative electrode tab group 25 of the electrode body 20. Next, the closing plate 14 is located over the electrode body 20 and the positive electrode tab group 23 of the electrode body 20 is bent in such a manner that the positive electrode second collector unit 52 and a side surface of the electrode body 20 on one side (left side in FIG. 3) face each other. By doing so, the positive electrode first collector unit 51 and the positive electrode second collector unit 52 are connected to each other. Likewise, the negative electrode tab group 25 of the electrode body 20 is bent in such a manner that the negative electrode second collector unit 62 and a side surface of the electrode body 20 on the other side (right side in FIG. 3) face each other. By doing so, the negative electrode first collector unit 61 and the negative electrode second collector unit 62 are connected to each other. As a result, the electrode body 20 is mounted on the closing plate 14 across the positive electrode collector unit 50 and the negative electrode collector unit 60.

Next, the electrode body 20 mounted on the closing plate 14 is accommodated in an electrode body holder 29 (see FIG. 3). The electrode body holder 29 can be prepared by bending an insulating resin sheet composed of a resin material such as polyethylene (PE) into a bag-like or box-like shape, for example. The electrode body 20 covered with the electrode body holder 29 is inserted into the battery case 10. At this time, the electrode body 20 can be inserted in such a manner as to be placed inside the battery case 10 in a direction in which the winding axis WL extends along the bottom surface 12a (specifically, in a direction in which the winding axis WL extends parallel to the long side direction Y). By doing so, it becomes possible to exhaust gas efficiently from the inside of the electrode body 20 in the degassing step S50 described later. Then, the closing plate 14 is joined to an edge of the opening 12h of the battery case 10 to seal the opening 12h. Preferably, the battery case 10 and the closing plate 14 are sealed with each other by weld connection, for example. The weld connection between the battery case 10 and the closing plate 14 can be formed by laser welding, for example. As a result, the electrode body 20 can be placed in the battery case 10.

Various insulating members for preventing electrical continuity between the electrode body 20 and the battery case 10 are mounted on the battery assembly 100. More specifically, an external insulating member 92 is interposed between the positive electrode external conductive member 32 (negative electrode external conductive member 42) and an outer side surface of the closing plate 14 (see FIGS. 2 and 3). Furthermore, a gasket 90 is fitted in each of the terminal fit holes 18 and 19 of the closing plate 14 (see FIG. 3). Moreover, an internal insulating member 94 is arranged between the positive electrode first collector unit 51 (or negative electrode first collector unit 61) and the inner side surface of the closing plate 14. A material for each of these insulating members is not particularly limited as long as it has certain insulating property. A synthetic resin material is usable and examples thereof include polyolefin-based resins (e.g., polypropylene (PP) and polyethylene (PE)), fluorine-based resins (e.g., perfluoroalkoxy alkane (PFA) and polytetrafluoroethylene (PTFE)).

Then, in the assembly constructing step S10, the prepared non-aqueous electrolytic solution is filled into the battery case 10 in which the electrode body 20 is accommodated. The non-aqueous electrolytic solution may be filled in an atmospheric-pressure environment or in a reduced-pressure environment. Preferably, the filling may proceed in a reduced-pressure environment. This allows the electrolytic solution to be filled faster. The amount of the non-aqueous electrolytic solution to be filled may be controlled properly at an amount that makes the non-aqueous electrolytic solution reach the electrode body 20 entirely. A conventional publicly-known electrolytic solution filling unit can be used appropriately in the filling of the non-aqueous electrolytic solution. After filling of the non-aqueous electrolytic solution, the liquid filling hole 15 of the closing plate 14 of the battery assembly is sealed. The liquid filling hole 15 can be sealed by incorporating the sealing member 16 having a shape conforming to the liquid filling hole 15. By doing so, the battery assembly 100 can be constructed.

In the initial charging step S20, the prepared battery assembly 100 is initially charged. The initial charging is a process of performing charging throughout a voltage region in which the manufactured non-aqueous electrolytic solution secondary battery is to be used. Performing the initial charging step S20 allows the battery assembly 100 to be activated electrochemically. A condition for the initial charging may be similar to that in a conventional case. While not particularly limited, the initial charging can be performed by charging with a current value from about 0.05 to 10 C in an ordinary temperature environment (25° C., for example) until a state of charge (SOC) from about 20 to 90% is obtained.

While not particularly limited, in the assembly constructing step S10, a preliminary charging step may be performed with timing after the filling of the non-aqueous electrolytic solution and before the sealing of the liquid filling hole 15. As described in Japanese Patent Application Laid-Open No. 2000-90974, this preliminary charging step may be performed for the purpose of exhausting gas generated by charging and discharging to the outside of the battery case 10, thereby reducing the amount of gas to be generated after sealing of the liquid filling hole 15 and preventing remaining of the gas in the electrode body 20 after the sealing before it occurs. The preliminary charging can be performed by charging with a current value from about 0.05 to 10 C in an environment of 25° C. until an SOC from about 10 to 80% is obtained.

As a result of implementation of the preliminary charging step, reaction responsive to the charging may proceed inside the electrode body 20. If the preliminary charging step is performed, taking too much time from completion of the preliminary charging step to start of the initial charging step is not preferred as it makes it likely that an SEI membrane will be formed excessively to cause reduction in battery capacity. From this viewpoint, a period from completion of the preliminary charging step to start of the initial charging step S20 is preferably equal to or less than 10 days, for example, more preferably, equal to or less than 3 days.

In the high-temperature holding step S30, the battery assembly 100 after being subjected to the initial charging step S20 is held for a predetermined duration at a high temperature equal to or greater than 40° C. By performing the high-temperature holding step S30 at a high temperature equal to or greater than 40° C., formation of an SEI membrane may be facilitated favorably on a surface of the negative electrode, for example. The high-temperature holding step S30 may be performed by leaving the battery assembly 100 at rest in a constant temperature bath, for example, configured to be maintained at a predetermined temperature. The high-temperature holding step S30 may be a step of holding the battery assembly 100 at a high temperature for a predetermined duration while maintaining a charged state as it is resulting from implementation of the initial charging step S20.

A too-low holding temperature in the high-temperature holding step S30 is not preferred as it does not facilitate formation of an SEI membrane sufficiently. From this viewpoint, the holding temperature in the high-temperature holding step S30 is equal to or greater than 40° C., for example, and may be equal to or greater than 50° C. or equal to or greater than 60° C. On the other hand, a too-high holding temperature in the high-temperature holding step S30 is not preferred as it may cause rapid formation of an SEI membrane to result in formation of the SEI membrane of an excessive quantity or result in a difficulty in forming the SEI membrane uniformly. From this viewpoint, the holding temperature in the high-temperature holding step S30 is preferably equal to or less than 85° C. more preferably, equal to or less than 80° C.

While a holding duration in the high-temperature holding step S30 depends on a set temperature, a battery size, etc. so cannot be defined generally, it may be from about 6 to 36 hours, for example, and can be set to a duration from about 12 to 24 hours as a guideline, for example. As an example, the high-temperature holding step S30 can be performed preferably by setting a holding temperature from 50 to 80° C. and setting a holding duration from 6 to 24 hours.

In the ordinary-temperature holding step S40, the battery assembly 100 after being subjected to the high-temperature holding step S30 is held in an ordinary-temperature environment for a duration exceeding 3 hours. The ordinary-temperature holding step S40 can be performed by leaving the battery assembly 100 at rest in a constant temperature bath configured to be maintained at an ordinary temperature (25° C.±10° C.), for example. As described above, performing the ordinary-temperature holding step S40 after the high-temperature holding step S30 allows reaction responsive to the charging to be nearly completed. This makes it possible to inhibit generation of additional gas inside the electrode body 20. As a result, the effects of performing the degassing step S50 described later can be exerted more favorably.

The ordinary-temperature holding step S40 is performed at an ordinary temperature, more specifically, at a temperature equal to or greater than 15° C. and equal to or less than 35° C. (preferably, equal to or greater than 20° C. and equal to or less than 30° C.). From the viewpoint of increasing the capacity of a secondary battery, the ordinary-temperature holding step S40 is performed for a holding duration exceeding 3 hours. As long as this holding duration exceeds 3 hours, it is not particularly limited but is preferably equal to or greater than 6 hours, for example, more preferably, equal to or greater than 12 hours, may be equal to or greater than 24 hours, or may be equal to or greater than 48 hours. From the viewpoint of increasing efficiency in manufacturing process, an upper limit of the holding duration in the ordinary-temperature holding step S40 is preferably equal to or less than 72 hours, for example, and may be equal to or less than 60 hours. The ordinary-temperature holding step S40 is preferably performed in an environment of an ordinary temperature (equal to or greater than 15° C. and equal to or less than 35° C.), for example, for a duration equal to or greater than 24 hours and equal to or less than 72 hours.

While not particularly limited, at least one of the high-temperature holding step S30 and the ordinary-temperature holding step S40 may include a pressing process of pressing the battery assembly 100. Specifically, at least one of the high-temperature holding step S30 and the ordinary-temperature holding step S40 may be performed while the battery assembly 100 is pressed (bound). At this time, the battery assembly 100 may be pressed (bound) in the laminating direction of the accommodated electrode body 20. This shortens an electrode distance between the positive electrode 22 and the negative electrode 24 of the electrode body 20, making it possible to reduce the amount of gas to remain in the electrode body 20 in the high-temperature holding step S30 and the ordinary-temperature holding step S40. A method of the pressing (binding) is not particularly limited but can employ a general procedure taken in the manufacturing of a conventional non-aqueous electrolytic solution secondary battery. For example, the battery assembly 100 can be pressed (bound) by interposing the longer walls 12b in a pair of the battery assembly 100 with binding plates and connecting the binding plates to each other with a bridge member.

If the battery assembly 100 is to be pressed in at least one of the high-temperature holding step S30 and the ordinary-temperature holding step S40, a pressure of this pressing is not particularly limited but may be controlled properly in response to the size of the battery assembly 100 or the winding of the electrode body 20, for example. Preferably, the pressure applied in pressing the battery assembly 100 in at least one of the high-temperature holding step S30 and the ordinary-temperature holding step S40 is set lower than a pressure of pressing in the degassing step S50 described later. In at least one of the high-temperature holding step S30 and the ordinary-temperature holding step S40, with a length L1 of the battery assembly 100 in the laminating direction before the pressing (see FIG. 2) defined as 100%, the battery assembly 100 is pressed so as to reduce the length L1 thereof in the laminating direction preferably by a range from 7.5 to 10%, more preferably, by a range from 7.5 to 8.6%, for example. In another case, in at least one of the high-temperature holding step S30 and the ordinary-temperature holding step S40, the battery assembly 100 may be pressed in the laminating direction of the electrode body 20 under a pressure equal to or greater than 0.05 kN and equal to or less than 4 kN (more preferably, equal to or greater than 0.05 kN and equal to or less than 0.15 kN).

In the degassing step S50, the battery assembly 100 after subjected to the ordinary-temperature holding step S40 is pressed at least once in the laminating direction of the electrode body 20 and then released. Performing this degassing step in conformity with timing after implementation of the ordinary-temperature holding step S40 allows gas to be exhausted from the inside to the outside of the electrode body 20, so that the remaining gas inside the electrode body 20 can be eliminated favorably.

According to the manufacturing method disclosed herein, performing the degassing step S50 with timing after implementation of the ordinary-temperature holding step S40 allows elimination of remaining of gas inside the electrode body 20 favorably even through pressing under a comparatively low pressure. Thus, it is possible to reduce a likelihood that the active material layer will be thinned due to application of an excessive pressure on the electrode body 20. Furthermore, equipment for the pressing can be simplified. Thus, the manufacturing method of this configuration realizes simplification of the equipment in addition to achieving manufacture of a non-aqueous electrolytic solution secondary battery with an improved battery capacity. While not particularly limited, in the degassing step S50, with the length L1 of the battery assembly 100 in the laminating direction before the pressing defined as 100%, the battery assembly 100 is pressed so as to reduce the length L1 thereof in the laminating direction preferably by a range from 7.5 to 10%, more preferably, by a range from 8.6 to 10%, still more preferably, by a range from 8.8 to 10%. In another case, in the degassing step S50, the battery assembly 100 may be pressed in the laminating direction of the electrode body 20 under a pressure equal to or greater than 0.1 kN and equal to or less than 5 kN (more preferably, equal to or greater than 0.15 kN and equal to or less than 1 kN).

If the pressing process is performed in at least one of the high-temperature holding step S30 and the ordinary-temperature holding step S40, a pressure of the pressing in the degassing step S50 is preferably set higher than a pressure of the pressing process in the high-temperature holding step S30 and the ordinary-temperature holding step S40. By doing so, it becomes possible to exhaust gas remaining inside the electrode body 20 more favorably to the outside of the electrode body 20.

In the degassing step S50, the battery assembly 100 is pressed in the laminating direction of the electrode body 20. In the illustrated example in FIG. 2, the longer walls 12b in a pair of the battery assembly 100 may be pressed from the opposite sides thereof in the short side direction X. At this time, with the area of a region in the presence of the positive electrode active material layer 22a of the electrode body 20 defined as 100%, the battery assembly 100 is preferably pressed at least in a region equal to or greater than 50%. This allows gas generated in response to reaction proceeding inside the electrode body 20 to be pushed out favorably to the outside of the electrode body 20. With the area of the region in the presence of the positive electrode active material layer 22a of the electrode body 20 defined as 100%, the pressing in the degassing step S50 is performed more preferably in a region equal to or greater than 55%, for example, may be performed in a region equal to or greater than 75%, in a region equal to or greater than 90%, or may be performed in a region of 100% (namely, the entire region in the presence of the positive electrode active material layer 22a), for example.

In the degassing step S50, pressing the battery assembly 100 at least once is sufficient and the number of times the battery assembly 100 is pressed is not particularly limited. For example, the battery assembly 100 may be pressed once or several times (namely, twice or more). In the degassing step S50, a duration of retaining the pressing is not particularly limited. Findings obtained by the present inventors show that, by pressing for about one second under a pressure such as that described above, for example, it becomes possible to eliminate the remaining sufficiently. A duration of retaining the pressing in the degassing step S50 is preferably at least equal to or greater than one second, may be equal to or greater than 10 seconds, or may be equal to or greater than one minute. From the viewpoint of manufacturing efficiency, a duration of retaining the pressing is preferably equal to or less than 24 hours, for example, more preferably, equal to or less than 12 hours, for example. In the degassing step S50, with the length L1 of the battery assembly 100 in the laminating direction before the pressing defined as 100%, the battery assembly 100 is pressed for a duration equal to or greater than one second so as to reduce the length L1 thereof in the laminating direction preferably by a range from 8.6 to 10%.

In the degassing step S50, after pressing the battery assembly 100, the battery assembly 100 is released. Here, “releasing the battery assembly” may include reducing a pressure of the pressing in addition to removing the battery assembly 100 completely from the binding member, etc. More specifically, the battery assembly 100 may be pressed under a pressure from 0.1 to 5 kN in the degassing step S50 and then may be released in such a manner that the battery assembly 100 is under a pressure less than the pressure of the pressing in the degassing step S50.

The non-aqueous electrolytic solution secondary battery obtained by the manufacturing method disclosed herein is available for various purposes and can be used suitably as a power source (driving power source) for motors installed on vehicles such as passenger cars or trucks, for example. While a vehicle type is not particularly limited, examples thereof include plug-in hybrid electric vehicles (PHEV), hybrid electric vehicles (HEV), and battery electric vehicles (BEV). The non-aqueous electrolytic solution secondary battery obtained by the manufacturing method disclosed herein can also be used suitably for constructing assembled batteries.

While some examples relating to the present disclosure will be described below, they are not intended to limit the present disclosure to these examples.

First, a lithium-nickel-cobalt-manganese composite oxide (NCM) as a positive electrode active material, acetylene black (AB) as a conductive material, and PVdF as a binder were prepared. These materials were mixed in N-methylpyrrolidone (NMP) as a solvent at a mass ratio of NCM:AB:PvDF=87:10:3, thereby preparing positive electrode active material layer forming slurry. The prepared slurry was applied in a strip shape to both surfaces of elongated aluminum foil and dried, thereby producing a positive electrode sheet.

Next, graphite (C) as a negative electrode active material, styrene-butadiene rubber (SBR) as a binder, carboxymethyl cellulose (CMC) as a dispersant were prepared. These materials were mixed in ion-exchanged water as a solvent at a mass ratio of C:SBR:CMC=98:1:1, thereby preparing negative electrode active material layer forming slurry. The prepared slurry was applied in a strip shape to both surfaces of elongated copper foil, thereby producing a negative electrode sheet.

Then, two sheets each including a heat resistant layer containing alumina and PVdF provided on a surface of a PE base material part were prepared as separator sheets. The produced positive electrode sheet and negative electrode sheet were laminated on each other in such a manner as to face each other across the separator sheets and wound, thereby producing an electrode body. A non-aqueous electrolytic solution was prepared by dissolving LiPF₆ at a concentration of 1.0 mol/L in a mixed solvent containing EC, EMC, and DMC at a volume ratio of 1:1:1. Then, the prepared wound electrode body and non-aqueous electrolytic solution were accommodated in a battery case, thereby constructing a battery assembly having a rectangular solid shape.

The battery assembly of Example 1 was subjected to preliminary charging by which the battery assembly was charged to an SOC of 5% at 1.0 C under a temperature environment of 25° C. After implementation of the preliminary charging, the battery assembly was left at rest at an ordinary temperature for 7 days. Next, the battery assembly was subjected to initial charging by which the battery assembly was charged to an SOC of 50% at a current value of 1.0 C and then this SOC was maintained. The battery assembly after the initial charging was subjected to a high-temperature holding step under conditions of a holding temperature of 65° C. and a holding duration of 13 hours. After the high-temperature holding step, an ordinary-temperature holding step was performed by which the battery assembly was held at an ordinary temperature (25° C.) for 3 hours. The high-temperature holding step and the ordinary-temperature holding step were performed while the battery assembly was pressed in a laminating direction of the electrode body. With a length of the battery assembly in the laminating direction before the pressing defined as 100%, the high-temperature holding step and the ordinary-temperature holding step were performed while the battery assembly was pressed so as to be reduced in length by 8.6%. After the ordinary-temperature holding step, a degassing step was performed. In the degassing step, with the length of the battery assembly in the laminating direction before pressing defined as 100%, the battery assembly was pressed in the laminating direction of the electrode body so as to be reduced in length by 8.8% and then released. At this time, the pressing was maintained for one second. In this way, a secondary battery for evaluation of Example 1 was produced.

### Example 2 to Example 5

A secondary battery for evaluation of Example 2 was produced in the same way as that of Example 1, except that a holding duration in an ordinary-temperature holding step was 6 hours.

A secondary battery for evaluation of Example 3 was produced in the same way as that of Example 1, except that a holding duration in an ordinary-temperature holding step was 12 hours.

A secondary battery for evaluation of Example 4 was produced in the same way as that of Example 1, except that a holding duration in an ordinary-temperature holding step was 24 hours.

A secondary battery for evaluation of Example 5 was produced in the same way as that of Example 1, except that a holding duration in an ordinary-temperature holding step was 48 hours.

### Comparative Example 1

A secondary battery for evaluation of Comparative Example 1 was produced in the same way as that of Example 1, except that an ordinary-temperature holding step and a degassing step were not performed after a high-temperature holding step.

### <Evaluation of Discharged Capacity>

The prepared secondary battery for evaluation of each Example was fully charged and fully discharged in an environment of 25° C., and a discharged capacity (mAh) measured during the discharging was determined to be a discharged capacity (mAh) of the secondary battery for evaluation of each Example. Result thereof is shown in FIG. 5. FIG. 5 shows a relationship between a discharged capacity ratio of each Example relative to a discharged capacity of Comparative Example 1 defined as 1 and a duration of implementation of the ordinary-temperature holding step. It can be said that a greater value of the discharged capacity ratio shows a larger battery capacity.

FIG. 5 shows that, in comparison to the secondary battery for evaluation of Comparative Example 1, a discharged capacity is improved in the secondary battery for evaluation of each of Example 1 to Example 5 subjected to the ordinary-temperature holding step and the degassing step. This is considered to be achieved as follows. By performing the ordinary-temperature holding step after the high-temperature holding step, reaction proceeds sufficiently inside the electrode body to inhibit generation of additional gas in a subsequent stage. Then, the degassing step is performed with timing after the ordinary-temperature holding step. This allows gas generated during the ordinary-temperature holding step to be pushed out favorably from the inside of the electrode body. As a result, the discharged capacity of the secondary battery for evaluation is increased.

Example 1 to Example 5 were compared to show that, in each of Example 2 to Example 5 in which the ordinary-temperature holding step was performed for a duration equal to or greater than 6 hours, the discharged capacity of the secondary battery for evaluation increases notably. This is thought to be achieved as follows. As a result of implementation of the ordinary-temperature holding step for a duration equal to or greater than 6 hours, reaction responsive to the charging is nearly completed. Thus, the degassing step can be performed with timing when generation of additional gas is inhibited. Specifically, it is considered that setting a holding duration in the ordinary-temperature holding step equal to or greater than 6 hours allows the amount of gas remaining inside the electrode body to be reduced easily, thereby improving the discharged capacity of the secondary battery for evaluation. This shows that holding in the ordinary-temperature holding step at an ordinary temperature for a duration exceeding 3 hours is preferable, and more preferably, at an ordinary temperature for a duration equal to or greater than 6 hours.

While some embodiments of the present disclosure have been described above, the embodiments are mere examples. The present disclosure can be carried out in various other embodiments. The present disclosure can be carried out on the basis of the contents disclosed in the present specification and technical knowledge in the pertinent field. The technology described in the claims include various modifications and changes from the embodiments described above as examples. For example, it is possible to replace some of the embodiments with other modifications or add other modifications to the embodiments. Unless one technical feature is described as being essential, this feature can be eliminated, as appropriate.

As described above, specific configurations of the technology disclosed herein can be provided in each of the following items.

Item 1: A method for manufacturing a non-aqueous electrolytic solution secondary battery including: a step of constructing a battery assembly in which an electrode body and a non-aqueous electrolytic solution are accommodated in a battery case, the electrode body including a positive electrode and a negative electrode laminated on each other across a separator; a step of initially charging the battery assembly; a high-temperature holding step of holding the battery assembly after subjected to the initial charging step at a high temperature equal to or greater than 40° C.; an ordinary-temperature holding step of holding the battery assembly at an ordinary temperature for a duration exceeding 3 hours after the high-temperature holding step; and a degassing step of pressing the battery assembly after subjected to the ordinary-temperature holding step in a laminating direction of the electrode body and releasing the battery assembly.

Item 2: The manufacturing method according to Item 1, wherein in the degassing step, the battery assembly is pressed in the laminating direction of the electrode body under a pressure equal to or greater than 0.1 kN and equal to or less than 5 kN.

Item 3: The manufacturing method according to Item 1 or 2, wherein in the degassing step, with a length of the battery assembly in the laminating direction before the pressing defined as 100%, the battery assembly is pressed so as to reduce the length of the battery assembly in the laminating direction by a range from 7.5 to 10%.

Item 4: The manufacturing method according to any one of Items 1 to 3, wherein in the ordinary-temperature holding step, the battery assembly is held at the ordinary temperature for a duration equal to or greater than 6 hours.

Item 5: The manufacturing method according to any one of Items 1 to 4, wherein at least one of the high-temperature holding step and the ordinary-temperature holding step further includes a pressing process of pressing the battery assembly in the laminating direction of the electrode body, and a pressure of the pressing in the degassing step is higher than a pressure of the pressing in the pressing process.

Item 6: The manufacturing method according to any one of Items 1 to 5, wherein the positive electrode includes a positive electrode collector and a positive electrode active material layer arranged on the positive electrode collector, the negative electrode includes a negative electrode collector and a negative electrode active material layer arranged on the negative electrode collector, in the electrode body, the positive electrode active material layer and the negative electrode active material layer are laminated on each other in such a manner as to face each other across the separator, and in the degassing step, with the area of a region in the presence of the positive electrode active material layer in the electrode body defined as 100%, the battery assembly is pressed in the laminating direction at least in a region equal to or greater than 50%.

What is claimed is:

1. A method for manufacturing a non-aqueous electrolytic solution secondary battery, comprising:
a step of constructing a battery assembly in which an electrode body and a non-aqueous electrolytic solution are accommodated in a battery case, the electrode body including a positive electrode and a negative electrode laminated on each other across a separator;
a step of initially charging the battery assembly;
a high-temperature holding step of holding the battery assembly after subjected to the initial charging step at a high temperature equal to or greater than 40° C.;
an ordinary-temperature holding step of holding the battery assembly at an ordinary temperature for a duration exceeding 3 hours after the high-temperature holding step; and
a degassing step of pressing the battery assembly after being subjected to the ordinary-temperature holding step in a laminating direction of the electrode body and releasing the battery assembly.

2. The manufacturing method according to claim 1, wherein
in the degassing step, the battery assembly is pressed in the laminating direction of the electrode body under a pressure equal to or greater than 0.1 kN and equal to or less than 5 kN.

3. The manufacturing method according to claim 1, wherein
in the degassing step, with a length of the battery assembly in the laminating direction before the pressing defined as 100%, the battery assembly is pressed so as to reduce the length of the battery assembly in the laminating direction by a range from 7.5 to 10%.

4. The manufacturing method according to claim 1, wherein
in the ordinary-temperature holding step, the battery assembly is held at the ordinary temperature for a duration equal to or greater than 6 hours.

5. The manufacturing method according to claim 1, wherein
at least one of the high-temperature holding step and the ordinary-temperature holding step further includes a pressing process of pressing the battery assembly in the laminating direction of the electrode body, and
a pressure of the pressing in the degassing step is higher than a pressure of the pressing in the pressing process.

6. The manufacturing method according to claim 1, wherein
the positive electrode includes a positive electrode collector and a positive electrode active material layer arranged on the positive electrode collector,
the negative electrode includes a negative electrode collector and a negative electrode active material layer arranged on the negative electrode collector,
in the electrode body, the positive electrode active material layer and the negative electrode active material layer are laminated on each other in such a manner as to face each other across the separator, and
in the degassing step, with the area of a region in the presence of the positive electrode active material layer in the electrode body defined as 100%, the battery assembly is pressed in the laminating direction at least in a region equal to or greater than 50%.
